(19) United States
(12) Patent Application Publication
(10) Pub. No.: US 2006/0223555 A1
(43) Pub. Date: Oct. 5, 2006

(54) Automatic time setting method for mobile terminals

(75) Inventor: Mi-Kyung Kim, Seoul (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/390,575

(22) Filed: Mar. 27, 2006

(30) Foreign Application Priority Data
Mar. 29, 2005 (KR) 10-2005-0026220

(51) Int. Cl. H04Q 7/20

(52) U.S. Cl. 455/466

(57) ABSTRACT

A method is provided for automatically setting time in a mobile terminal, whereby the mobile communication terminal can automatically set time in an asynchronous mobile communication system. By providing a message to the mobile terminal that includes time information, the mobile terminal may automatically set the time rather than a user having to manually enter time.

### CROSS-REFERENCE TO RELATED APPLICATIONS

Pursuant to 35 U.S.C. § 119(a), this application claims the benefit of earlier filing date and right of priority to Korean Application No. 26220/2005, filed on Mar. 29, 2005, the contents of which is hereby incorporated by reference herein in its entirety.

### BACKGROUND OF THE INVENTION

1. Field of the Invention

The present invention relates to a mobile terminal, and more particularly, to a method for automatically setting time in a mobile terminal, whereby the mobile communication terminal can automatically set time in an asynchronous mobile communication system.

2. Description of the Related Art

In general, mobile communication is classified into synchronous mobile communication, which adopts a global positioning system (GPS) and is mostly used in North America, and asynchronous mobile communication, which does not adopt the GPS and is mostly used in Europe. Presently, the representative synchronous mobile communication system is code division multiple access 2000 (CDMA2000) and the representative asynchronous mobile communication systems are general packet radio services (GPRS) and global system for mobile communications (GSM).

Although a user does not input time to a mobile terminal in a synchronous mobile communication system, such as CDMA2000, when the mobile terminal is powered on, the mobile terminal performs a terminal resetting process for synchronization with the system (base station) to automatically adjust the time. In this way, all mobile terminals can always maintain the precise time.

However, unlike a mobile terminal used in a synchronous mobile communication system, a mobile terminal used in an asynchronous mobile communication system, such as GSM or GPRS, is not provided with time information from the system. Therefore, users of mobile terminals in asynchronous mobile communication systems must input time to the mobile terminals manually.

Therefore, there is a need for a method to automatically set time in a mobile terminal uses in an asynchronous mobile communication system. The present invention addresses these and other needs.

### SUMMARY OF THE INVENTION

Features and advantages of the invention will be set forth in the description which follows, and, in part, will be apparent from the description or may be learned by practice of the invention. The objectives and other advantages of the invention will be realized and attained by the structure particularly pointed out in the written description and claims hereof as well as the appended drawings.

The invention is directed to provide a method for automatically setting time in a mobile terminal, whereby the mobile communication terminal can automatically set time in an asynchronous mobile communication system. By providing a message to the mobile terminal that includes time information, the mobile terminal may automatically set the time rather than a user having to manually enter time.

In one aspect of the invention, a method for setting time in a mobile terminal is provided. The method includes receiving an SMS message including time information and setting the time according to the time information.

It is contemplated that the method further includes receiving the SMS message from a short message service center of a mobile communication system. Preferably, the method further includes determining that a transport protocol user data header indicator in the SMS message has a value of ‘1’.

It is contemplated that the method further includes extracting the time information from an information element of a user data header in the SMS message. Preferably, the method further includes extracting the time information from an information element having an information element identifier in the range of 0*E0 to 0*FF.

It is contemplated that the method further includes determining whether the SMS message includes the time information, the determination performed according to the information element identifier. It is further contemplated that the method includes extracting the time information and setting the time only if it is determined that the SMS message includes the time information. Preferably, the method further includes deleting the SMS message after setting the time without indicating reception of the SMS message to a user.

In another aspect of the invention, a method for setting time in a mobile terminal is provided. The method includes transmitting a request for current time information, receiving the requested time information and setting the time according to the received time information.

It is contemplated that the method further includes receiving the time information from a short message service center. Preferably, receiving the time information includes receiving an SMS message to which the time information has been added.

It is contemplated that the method further includes determining that a transport protocol user data header indicator of the SMS message has a value of ‘1’. Preferably, the method further includes extracting the time information from an information element of a user data header in the SMS message.

It is contemplated that the method further includes extracting the time information from an information element having an information element identifier in the range of 0*E0 to 0*FF. It is further contemplated that the method further includes determining whether the SMS message includes the requested time information, the determination performed according to the information element identifier. Preferably, the method further includes extracting the time information only if it is determined that the SMS message includes the requested the time information.

In another aspect of the invention, a method for setting time in a mobile terminal is provided. The method includes receiving a request for current time information and transmitting an SMS message to a mobile terminal from which the request was received, the SMS message including the requested time information.

It is contemplated that the method further includes setting a transport protocol user data header of the SMS message to a value at ‘1’. Preferably, the method further includes including the requested time information in an information element of a user data header of the SMS message.

It is contemplated that the information element has a data length of 6 octets and includes 6 bytes of information element data containing the requested time. It is further contemplated that the information element data includes information of year, month, day, hour, minute and second in each octet for a total 6 bytes. Preferably, the method further includes including the requested time information in an information element having an information element identifier in the range of 0*E0 to 0*FF.

Additional features and advantages of the invention will be set forth in the description which follows, and, in part, will be apparent from the description or may be learned by practice of the invention. It is to be understood that both the foregoing general description and the following detailed description of the present invention are exemplary and explanatory and are intended to provide further explanation of the invention as claimed. These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a flowchart showing sequential steps of a method for automatically setting time for a mobile terminal in accordance with one embodiment of the present invention.

FIG. 2 illustrates a detailed structure of an SMS message for a method for automatically setting time for a mobile terminal in accordance with one embodiment of the present invention.

### DETAILED DESCRIPTION OF THE PREFERRED EMBODIMENTS

The present invention relates to method for automatically setting time in a mobile terminal, whereby the mobile communication terminal can automatically set time in an asynchronous mobile communication system. Although the present invention is illustrated with respect to a mobile communication device, it is contemplated that the present invention may be utilized anytime it is desired to allow a communication device to automatically set time.

Reference will now be made in detail to the preferred embodiments of the present invention, examples of which are illustrated in the accompanying drawings. Well-known functions or constructions are not described in detail since they would obscure the invention with unnecessary detail.

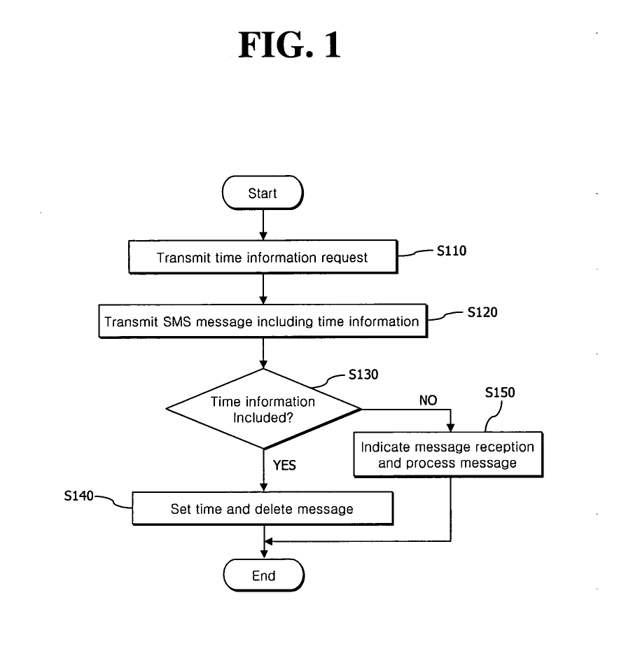

FIG. 1 is a flowchart illustrating sequential steps of a method for automatically setting time for a mobile terminal in accordance with one embodiment of the present invention. Referring to FIG. 1, when the mobile terminal is powered on, the mobile terminal transmits a time information request to a system using a predefined address (S110). The system can be a short message service center (SMSC) that transmits a short message service (SMS) message.

The SMSC, upon receiving the time information request from the mobile terminal, recognizes that the mobile terminal desires to receive time information on the basis of the address, creates an SMS message including time information and transmits the SMS message to the mobile terminal (S120). The mobile terminal, upon receiving the SMS message, determines whether the SMS includes the requested time information or is a general message by parsing the message (S130).

If the message includes the time information, the mobile terminal sets time by using the time information data and deletes the message without indicating to the user that the message was received (S140). If the message is a general SMS message, the mobile terminal indicates to the user that the message was received and displays the message on a screen, deletes the message or stores the message according to a command from the user (S150).

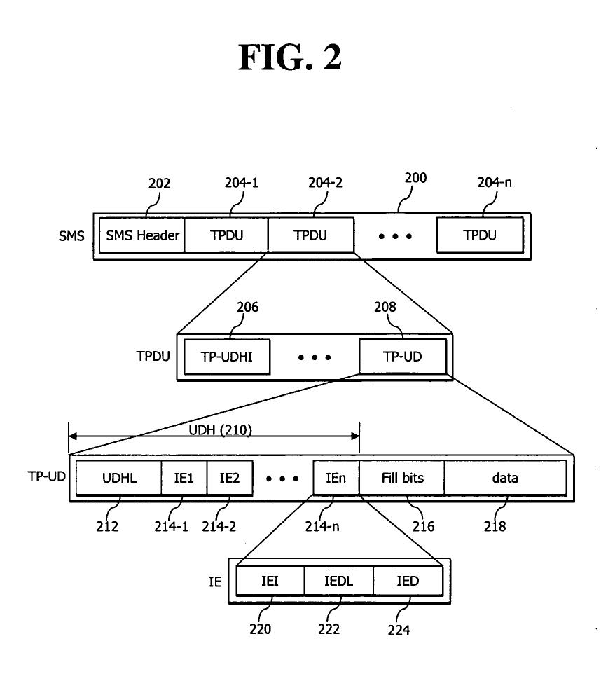

In order to support the method illustrated in FIG. 1, the SMS message must contain a specific structure so that the time information can be added to the SMS message and the mobile terminal can parse the message. The specific structure of the SMS message will be explained with reference to FIG. 2.

FIG. 2 illustrates a detailed structure of an SMS message to support a method for automatically setting time for a mobile terminal in accordance with one embodiment of the present invention. Pursuant to the SMS specification, the SMSC transmits the SMS message to the mobile terminal using an SMS_DELIVER transaction type.

As illustrated in FIG. 2, the SMS message 200 includes an SMS header 202 having message information and a plurality of transport protocol data units (TPDU) 204-1 to 204-n. Each TPDU 204-1 to 204-n includes various fields. A transport protocol user data header indicator (TP-UDHI) 206 indicates transport protocol user data (TP-UD) 208 in the form of information element identifiers (IEI).

When the TP-UDHI 206 has a value of ‘1’, part of the TP-UD 208 including actual message contents is regarded as a user data header (UDH) 210, thereby enabling the mobile terminal to recognize the existence of other information and to parse the message. The TP-UD 208 includes the UDH 210, fill bits 216 and data 218. The UDH 210 includes a UDH length (UDHL) 212 indicating a length of the UDH 210 and a plurality of information elements (IE) 214-1 to 214-n.

In accordance with the present invention, the SMSC transmits the time information to the mobile terminal using the IEs 214-1 to 214-n of the UDH 210, which include other information, rather than the actual contents of the SMS message. The mobile terminal receives the time information and automatically sets the time.

The SMSC, upon receiving the time information request from the mobile terminal, transmits the SMS message 200 after setting the TP-UDHI 206 as ‘1’ and adding the time information to the IEs 214-1 to 214-n. According to the SMS specification, the IEI 220 of the IE structure 214-1 to 214-n ranges from 0*00 to 0*FF. Furthermore, the range of 0*E0 to 0*FF of the IEI 220 is reserved for future use. In the present invention, one value in the range of 0*E0 to 0*FF of the IEI 220 is defined and used to indicate the time information to the user.

Additionally, the SMSC generates the SMS message 200 having an IE data length (IEDL) 222 of 0*06 containing 6 octets and an IE data (IED) 224 including information indicating year, month, day, hour, minute and second in each octet, for a total 6 bytes. The SMSC transmits the SMS message 200 to the mobile terminal that transmitted the time information request. The mobile terminal, upon receiving the SMS message 200, determines whether the message 200 includes the requested time information data on the basis of the IEI 220 when the message 200 is parsed.

If the message 200 includes the requested time information data, the mobile terminal extracts the data including the time information of 6 bytes indicating year, month, day, hour, minute and second from the IED 224 corresponding to 6-octet IEDL 222 and stores the extracted data in a temporary memory. The mobile terminal sets the time using the stored time information data and deletes the message 200 after setting the time without indicating reception of the message 200 to the user.

On the other hand, if the received message does not include the requested time information data, but is a general SMS message, such as in the conventional method, the mobile terminal indicates reception of the message to the user. The mobile terminal then displays the message on a screen, deletes the message or stores the message according to a command from the user.

For example, if 0*E1 is defined as a time information notifying value, the SMSC generates an SMS message in which the IEI of the IE is 0*E1 (IEI=0*E1), the IEDL is 0*06 having 6 octets (IEDL=0*06) and the IED includes information indicating year, month, day, hour, minute and second in each octet, for a total 6 bytes. The SMSC then transmits the SMS message to the mobile terminal that transmitted the time information request.

The mobile terminal receiving the SMS message recognizes that the message includes the requested time information data on the basis of the IEI (0*E1) when the message is parsed, extracts most of the 6 bytes of data including the time information indicating year, month, day, hour, minute and second from the IED corresponding to 6-octet IEDL 222, and stores the extracted data in a temporary memory. The mobile terminal sets the time using the stored time information data and deletes the message after setting the time without indicating reception of the message to the user.

The method for automatically setting time for a mobile terminal according to the present invention can automatically set time in a mobile terminal in an asynchronous mobile communication system. By automatically setting the time, a user is not required to manually input time and convenience is increased.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims. Therefore, all changes and modifications that fall within the metes and bounds of the claims, or equivalence of such metes and bounds are therefore contemplated by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for setting time in a mobile terminal, the method comprising:
receiving an SMS message comprising time information; and
setting the time according to the time information.

2. The method of claim 1, further comprising receiving the SMS message from a short message service center of a mobile communication system.

3. The method of claim 1, further comprising determining that a transport protocol user data header indicator in the SMS message has a value of ‘1’.

4. The method of claim 1, further comprising extracting the time information from an information element of a user data header in the SMS message.

5. The method of claim 4, further comprising extracting the time information from an information element having an information element identifier in the range of 0*E0 to 0*FF.

6. The method of claim 5, further comprising determining whether the SMS message comprises the time information, the determination performed according to the information element identifier.

7. The method of claim 6, further comprising extracting the time information and setting the time only if it is determined that the SMS message includes the time information.

8. The method of claim 7, further comprising deleting the SMS message after setting the time without indicating reception of the SMS message to a user.

9. A method for setting time in a mobile terminal, the method comprising:
transmitting a request for current time information;
receiving the requested time information; and
setting the time according to the received time information.

10. The method of claim 9, further comprising receiving the time information from a short message service center.

11. The method of claim 9, wherein receiving the time information comprises receiving an SMS message to which the time information has been added.

12. The method of claim 11, further comprising determining that a transport protocol user data header indicator of the SMS message has a value of ‘1’.

13. The method of claim 11, further comprising extracting the time information from an information element of a user data header in the SMS message.

14. The method of claim 13, further comprising extracting the time information from an information element having an information element identifier in the range of 0*E0 to 0*FF.

15. The method of claim 14, further comprising determining whether the SMS message includes the requested time information, the determination performed according to the information element identifier.

16. The method of claim 15, further comprising extracting the time information only if it is determined that the SMS message includes the requested the time information.

17. A method for setting time in a mobile terminal, the method comprising:
receiving a request for current time information; and
transmitting an SMS message to a mobile terminal from which the request was received, the SMS message including the requested time information.

18. The method of claim 17, further comprising setting a transport protocol user data header of the SMS message to a value at ‘1’.

19. The method of claims 17, further comprising including the requested time information in an information element of a user data header of the SMS message.

20. The method of claim 19 wherein the information element has a data length of 6 octets and comprises 6 bytes of information element data containing the requested time.

21. The method of claim 20, wherein the information element data comprises information of year, month, day, hour, minute and second in each octet for a total 6 bytes.

22. The method of claim 19, further comprising including the requested time information in an information element having an information element identifier in the range of 0*E0 to 0*FF.
